(19) United States
(12) Patent Application Publication
(10) Pub. No.: US 2004/0227774 A1
(43) Pub. Date: Nov. 18, 2004

(54) Control program for image processing device

(75) Inventor: Kenji Matsumoto, Chino-shi (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 10/799,582

(22) Filed: Mar. 12, 2004

(30) Foreign Application Priority Data
Mar. 13, 2003 (JP) 2003-068336

(51) Int. Cl. G09G 5/10

(52) U.S. Cl. 345/690

(57) ABSTRACT

An image display system includes an image processing device and an electro-optic apparatus. The electro-optic apparatus includes a pixel matrix, where pixels including optical elements are arranged in a matrix shape, a plurality of scanning lines coupled to a pixel group arranged along either one of a row direction or a column direction of the pixel matrix, a plurality of data lines coupled to the pixel group arranged along either one of the row direction or the column direction of the pixel matrix and a scanning-line driving circuit that sequentially selects the plurality of scanning lines one by one. A data-line driving circuit outputs a control signal related to light emission of the optical elements to, at least, one data line of the plurality of data lines. A control section controls an operation of the scanning-line driving circuit and the data-line driving circuit and an input image data acquisition section obtains input image data transmitted from the image processing device. The image processing device generates the input image data to be inputted into the electro-optic apparatus and transmits the input image data to the electro-optic apparatus. The control section controls the light emission time of the optical elements by a non-sequential scanning operation that selects a scanning line in a discontinuous order against an arranged order of the scanning lines, based on gradation data of a predetermined bit length corresponding to the input image data and a number of light emission gradation of the optical element, and gradationally displays an input image on a display area defined by a predetermined number of the scanning lines and the data lines.

### BACKGROUND OF THE INVENTION

1. Field of the Invention

The present invention relates to a system that displays an image on an electro-optic apparatus by a non-sequential scanning process suited for suppressing a display irregularity of an image by gradation display, and in particular, to an image processing device that transmits image data to the electro-optic apparatus.

2. Description of the Related Art

Conventionally, an electro-optic apparatus, for example, a liquid crystal display using a liquid crystal as an electro-optic material has been widely used as a display device replacing a cathode-ray tube (CRT) for a display portion of various information processing equipment, a liquid crystal television or the like. A conventional electro-optic apparatus includes, for example, a pixel electrode arranged in a matrix shape, an element substrate where switching elements coupled to the pixel electrode are formed, a counter substrate where a counter-electrode opposing the pixel electrode is formed, and a liquid crystal as an electro-optic material filled between both electrodes. Then, in such a configuration, when selecting a certain scanning line, the switching element is in a conduction state. When applying an image signal with a voltage according to a gradation to a pixel electrode through a data line during the conduction state, the charge corresponding to the voltage of the image signal is accumulated in the liquid crystal layer between the pixel electrode and the counter-electrode. After the charge accumulation, the accumulated charge in the liquid crystal layer is retained by the capacitive characteristic and storage capacitance of the liquid crystal layer even if the switching element is turned off. When driving each switching element and controlling the amount of charge to store according to the gradation in this way, the orientation condition the of liquid crystal changes for each pixel element. For this reason, the density changes for each pixel, thereby a gradation display can be performed.

At this time, because a part of the period may be sufficient for storing a charge to the liquid crystal layer of each pixel, a time-division-multiplex driving, that makes the scanning line and the data line common for a plurality of pixels, can be attained by the configuration where each scanning line is sequentially selected, first, while an image signal having a voltage according to the gradation of the pixel is next applied to the corresponding data line of the pixel that intersects the selected scanning line.

However, the image signal applied to the data line is a voltage corresponding to the gradation of the pixel, that is, an analog signal. For this reason, a D/A-conversion circuit, an operational amplifier or the like are required for the periphery circuit of the electro-optic apparatus, thereby inviting an increase in cost of the entire apparatus. Furthermore, because display irregularities occur due to the characteristics of the D/A-conversion circuit, the operational amplifier or the like and non-uniformity of various kinds of wiring resistances, there is a problem that a high quality display becomes very difficult and the irregularities become significant especially when carrying out a high definition display. Moreover, an increase of consuming power caused by the D/A-conversion circuit and the operational amplifier or the like is also a problem.

Thus, a method of obtaining the gradation by controlling the light emission time of an electro-optic device has been developed. In this method, a binary signal (digital signal) that makes the electro-optic devices emit light or not emit light to the data line has been provided. Accordingly, there is an advantage that the above-described analog circuit giving a bad influence to the quality of the image is not required. However, a problem that it takes too much time to select scanning lines when carrying out the control has emerged.

Then, a non-sequential scanning method has been developed as a driving method for a liquid crystal display by using the digital signal in order to solve the above-described problem. In this method, the light emission gradation of an optical element is expressed by the gradation data of a bit length of N. Then, a numerical group according to the proportion of a 2ⁿ value (n=0, 1, 2 through (N−1)) of the number of bits of a bit string constituting the gradation data, is generated, and the scanning lines are non-sequentially selected by using the numerical group. Thus, the light emission time of the optical element is controlled by non-sequentially selecting the scanning lines. That is, the gradation display is carried out by controlling the light emission time in accordance with the light emission gradation.

However, in the above-described non-sequential scanning method, the process becomes complicated (requiring the rearrangement of pixel data or the like) as compared with the conventional sequential scanning. Therefore, if all of the processes are to be conducted by the electro-optic apparatus, sufficient capacity for the frame memory, a high-speed processor or dedicated hardware or the like is required and thus there is a problem of inviting an increase in cost of the electro-optic apparatus.

The present invention has been made in view of the unsolved problems that conventional technologies have, and has a feature of providing a control program for an image processing device that controls the image processing device in an image display system, which can reduce the cost of the electro-optic apparatus.

### SUMMARY OF INVENTION

In order to achieve the above-described advantage, a control program for an image processing device according to the present invention is provided, which controls the image processing device in an image display system, and after having obtained a selection order of scanning lines corresponding to image data and a non-sequential scanning operation, the control program rearranges pixel data constituting the image data according to the selection order of scanning lines corresponding to the non-sequential scanning operation. The image display system, includes an electro-optic apparatus including a pixel matrix, where pixels including optical elements are arranged in a matrix shape a plurality of scanning lines coupled to a pixel group arranged along either one of the row direction and the column direction of the pixel matrix, a plurality of data lines coupled to the pixel group arranged along either one of the row direction and the column direction of the pixel matrix and a scanning-line driving circuit that sequentially selects the plurality of scanning lines one by one. The image display system also includes a data-line driving circuit that outputs a control signal related to light emission of the optical elements to, at least, one data line of the plurality of data lines, a control section that controls the operation of the scanning-line driving circuit and the data-line driving circuit, an input image data acquisition section that obtains input image data transmitted from an image processing device and the image processing device that generates the input image data to be inputted into the electro-optic apparatus and transmits the input image data to the electro-optic apparatus. The image display system includes the control section that controls the light emission time of the optical element by non-sequential scanning that selects the scanning line in discontinuous order against the arranged order of the scanning lines. This is based on gradation data of a predetermined bit length corresponding to the input image data and the number of light emission gradation of the optical element. The control section gradationally displays the input image on a display area defined by a predetermined number of the scanning lines and the data lines.

That is, according to the first embodiment of the present invention, because the pixel data of the image data can be rearranged in order corresponding to the non-sequential scanning by the image processing device, a process of rearranging the pixel data by the electro-optic apparatus is not required, thereby enabling to simplify the hardware configuration such as a reduction of the capacity of the frame memory and simplification of the control section of the electro-optic device. Therefore, cost reduction can be attained.

The above-described optical element refers to, for example, a liquid crystal, an electroluminescent element, a plasma display, a light emitting diode or the like. Moreover, a second embodiment of the present invention transmits a predetermined amount of the pixel data, whose rearrangement has been completed in the first embodiment of the present invention, to the electro-optic apparatus every time the rearrangement is complete.

That is, according to the second embodiment of the present invention, the predetermined amount of pixel data, which constitute the data to be inputted to the image processing apparatus, can be transmitted to the electro-optic apparatus every time the rearrangement is complete. Accordingly, at the electro-optic apparatus, because the non-sequential scanning operation can be carried out for each pixel data of the predetermined amount of pixel data, whose rearrangement has been completed and transmitted from the image processing device, reduction of the memory capacity by the electro-optic apparatus can be attained. Thereby, a reduction in cost can be attained.

A method according to an embodiment of the present invention includes obtaining a bit length N of the gradation data indicating light emission gradation of the optical element and a numerical group obtained by dividing the added number, obtained by adding one to the total number of the scanning lines, with the proportion including 2ⁿ values (n=0, 1 and 2 through (N−1)) of the number of bits in a bit string constituting the gradation data and associating a serial number to each of the scanning lines with the order of the scanning lines. The method also includes assigning a predetermined number of the serial numbers, which have been associated to the scanning lines, as the initial value corresponding to the least significant bit (0th digit) of the bit string constituting the gradation data, assigning a number, obtained by adding the largest number contained in the numerical group to the initial value corresponding to the least significant bit, as the initial value of the scanning line corresponding to the most significant bit ((N−1) digit) of the bit string constituting the gradation data and associating an added value, obtained by adding one to the bit-digit of the other bit from the lower bit-digit, as an initial value of the other bit, out of the initial value corresponding to one digit higher than the bit-digit of the other bit and the numerical values contained in the numerical group, sequentially from the higher bit-digit of the other bits, concerning the other bits between the most significant bit and the least significant bit.

The method further includes a first processing that selects the scanning line of the serial number indicated by the initial value corresponding to the least significant bit at first, and that sequentially selects each of the scanning lines of the serial number indicated by the initial values corresponding to the most significant bit and each bit, which is shifted bit by bit from the most significant bit towards the bit before the least significant bit, a second processing that makes the scanning-line driving circuit drive the scanning line of the selected number every time the scanning line is selected, a third processing that adds one to the value that has been associated with each bit of the gradation data, respectively, while if the value corresponding to each bit of the gradation data after the addition exceeds the value, obtains by subtracting one from the total number of the scanning lines, and updates the value to the minimum value of the serial number and a fourth processing that selects the scanning line, corresponding to the value that has been associated with each bit of the gradation data after the third processing, with the same sequence of the first processing. The control program for the image processing device determines the selection order of the scanning lines by repeating the second processing through the fourth processing until all the scanning lines on the display area have been selected for each bit of the bit string constituting the gradation data and generates the input image data based on the determined selection order.

That is, according to this embodiment of the present invention, in the electro-optic apparatus having an arbitrary number of scanning lines, the selection order of the scanning lines in the non-sequential scanning operation can be determined with ease.

### BRIEF DESCRIPTION OF THE DRAWINGS

FIG. 1 shows a block diagram illustrating a configuration of an image display system 1 according to a first embodiment of the present invention.

FIG. 2 shows a view illustrating a data array for image data to be inputted to the image processing device 10.

FIG. 3 shows a view illustrating a data array for input image data generated in the input image data generation section 10a.

FIG. 4 shows a view illustrating the interrelationship between image data and pixel data.

FIG. 5 shows a view illustrating display order of the pixel data after having been rearranged in the input image data generation section 10a.

FIG. 6(a) shows a view illustrating a situation of scanning lines being selected when the number of scanning lines of the display area is fourteen lines and the gradation data is four bits, FIG. 6(b) shows a view illustrating the relationship between the scanning lines and the pixels in the panel 11a, and FIG. 6(c) shows a view illustrating the configuration of pixel data.

FIG. 7 is a flow chart showing the acquisition processing of image data in the image processing device 10.

FIG. 8 is a flow chart showing a generation processing of input image data and a transmission processing of input image data in the image processing device 10.

FIG. 9 is a flow chart showing write processing of input image data into the frame memory 11e in the electro-optic apparatus 11.

FIG. 10 is a flow chart showing a display processing of image by the non-sequential scanning in the electro-optic apparatus 11.

FIG. 11 shows a block diagram illustrating a configuration of an image display system 2 according to a second embodiment of the present invention.

FIG. 12 is a flow chart showing a generation processing of input image data and a transmission processing of input image data in the image processing device 10.

FIG. 13 is a flow chart showing a write processing of input image data to the line memory 11g in the electro-optic apparatus 11′.

FIG. 14 is a flow chart showing a display processing of image by the non-sequential scanning in the electro-optic apparatus 11′.

### DESCRIPTION OF THE PREFERRED EMBODIMENTS

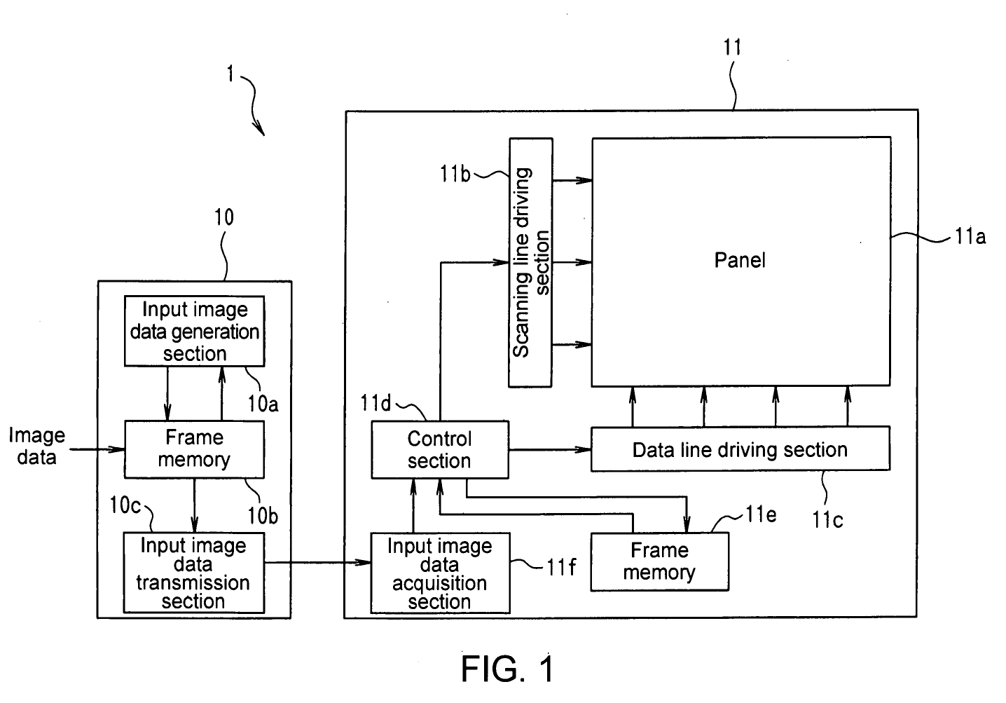

Hereinafter, preferred embodiments of the present invention will be described with reference to drawings. FIG. 1 through FIG. 14 shows views illustrating embodiments of the image display system according to the present invention. First, the image display configuration of the image display system according to a first embodiment of the present invention will be described with referring to FIG. 1. FIG. 1 is a block diagram showing the configuration of an image display system 1 according to the first embodiment of the present invention.

The image display system 1 includes an image processing device 10 and an electro-optic apparatus 11. The image processing device 10 includes an input image data generation section 10a, a frame memory 10b and an input image data transmission section 10c. The input image data generation section 10a carries out the processing of image data, obtained from an apparatus such as a personal computer (PC), to generate input image data rearranged according to the selection order of the scanning lines in the image display by a non-sequential scanning operation in the electro-optic apparatus 11. The generated input image data of one image is stored in the frame memory 10b as a binary file.

The frame memory 10b is a memory for storing the image data inputted from a device such as PC or the like. The memory is equipped with a capacity of simultaneously storing at least two sheets of image data. In the present embodiment, the memory is assumed to have two storage regions, a storage region 1 and a storage region 2. The image data transmission section 10c transmits the input image data stored in the frame memory 10b to the electro-optic apparatus 11.

Although not shown here, the image processing device 10 includes a processor such as a Central Processing Unit (CPU) for carrying out a control program for controlling each part of the above-described parts, and a Read Only Memory (ROM) where the program is stored, thereby carrying out various control processes by reading out and carrying out the control program from the ROM.

The electro-optic apparatus 11 includes a panel 11a, a scanning-line driving section 11b, a data-line driving section 11c, a control section 11d, a frame memory 11e, and an input image data acquisition section 11f. The panel 11a includes a pixel circuit, which includes a switching transistor, a driving transistor, an optical element, and a hold capacitor, provided at the intersection of a plurality of scanning lines and a plurality of data lines in a matrix shape. The image is displayed by gradation on the panel by controlling the light emission time of the optical element according to the bit length of the gradation data that will be described later.

The scanning-line driving section 11b drives the scanning lines under the control of the control section 11d (described later) based on the selection order of the scanning lines in the non-sequential scanning operation. The data-line driving section 11c drives the data lines under the control of the control section 11d (described later). Based on the input image data obtained from the image processing device 10, the control section 11d makes the scanning-line driving section 11b select the scanning line of the image display area on the panel 11a with a certain sequence by the non-sequential scanning operation, and drives the pixel circuit corresponding to the selected scanning line by providing the data signal to the data-line driving section 11c.

The frame memory 11e is a memory for storing the input image data from the image processing device 10, including two storage regions for conducting data writing and reading in a parallel manner. The two storage regions of the frame memory 11e are referred to as a frame memory A and a frame memory B. The input image data acquisition section 11f obtains input image data from the image processing device 10 at predetermined times. The obtained input image data is stored in the frame memory 11e through the control section 11d.

As for the pixel circuit that constitutes the panel 11a according to the present embodiment, the operation thereof is controlled based on a bright signal, which is written as “high” or “low”, provided through a data line from the control section 11d, and based on the driving of the scanning line and the data line by the scanning-line driving section 11b and the data-line driving section 11c. And, regardless of the scanning line being driven or not, the pixel circuit makes the optical element emit light when the bright signal is written as “high”, and makes the optical element not emit light when the bright signal is written as “low”. In the present embodiment, the optical element is assumed to be an electroluminescent element.

The electro-optic apparatus 11 according to the present embodiment makes the signal (bright signal) applied to the data line as a binary bit data, while controlling the light emission time of the optical element during one frame period by using the bit data. That is, the gradation display of the image is carried out by controlling the light emission time of the optical element according to the time corresponding to each bit of the bit string constituting the gradation data.

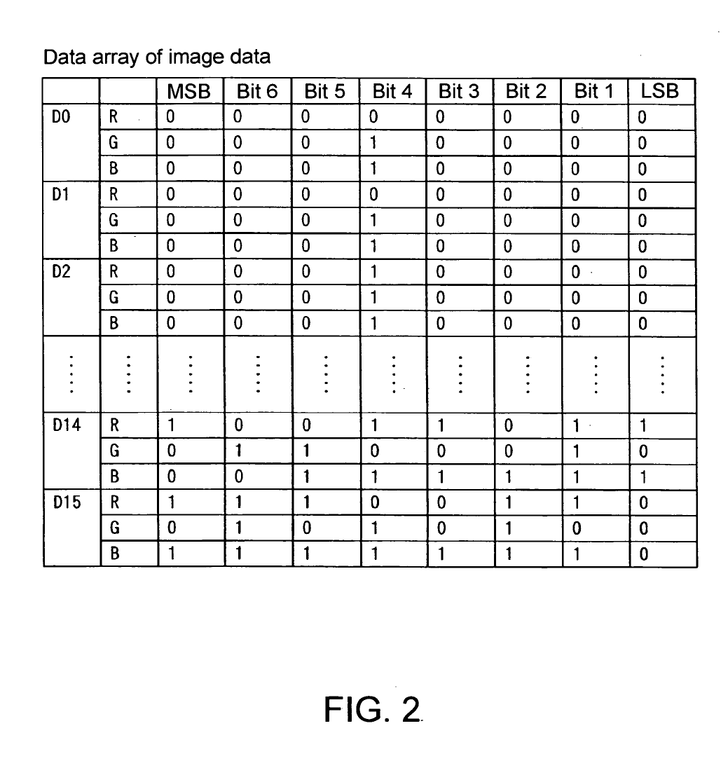

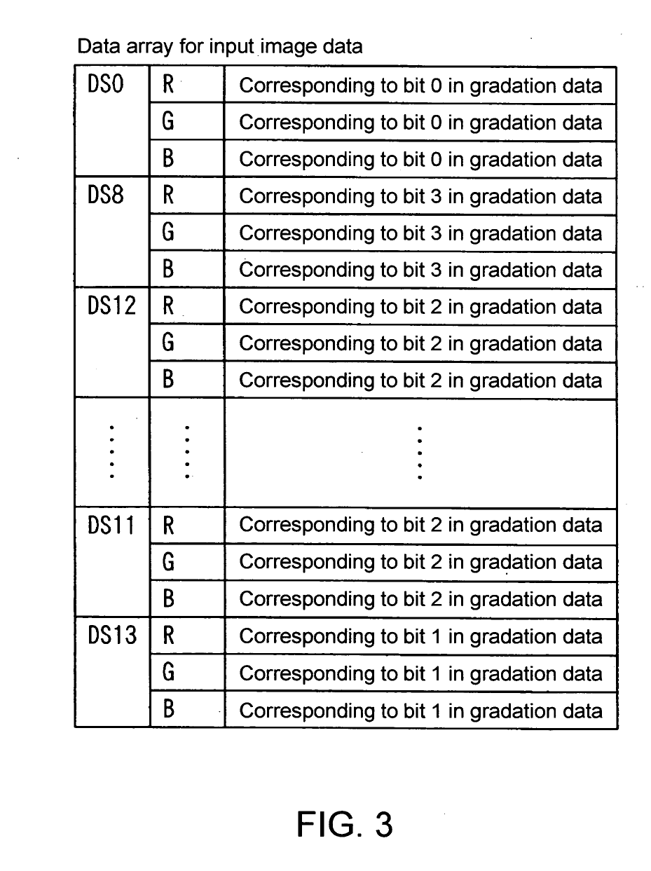

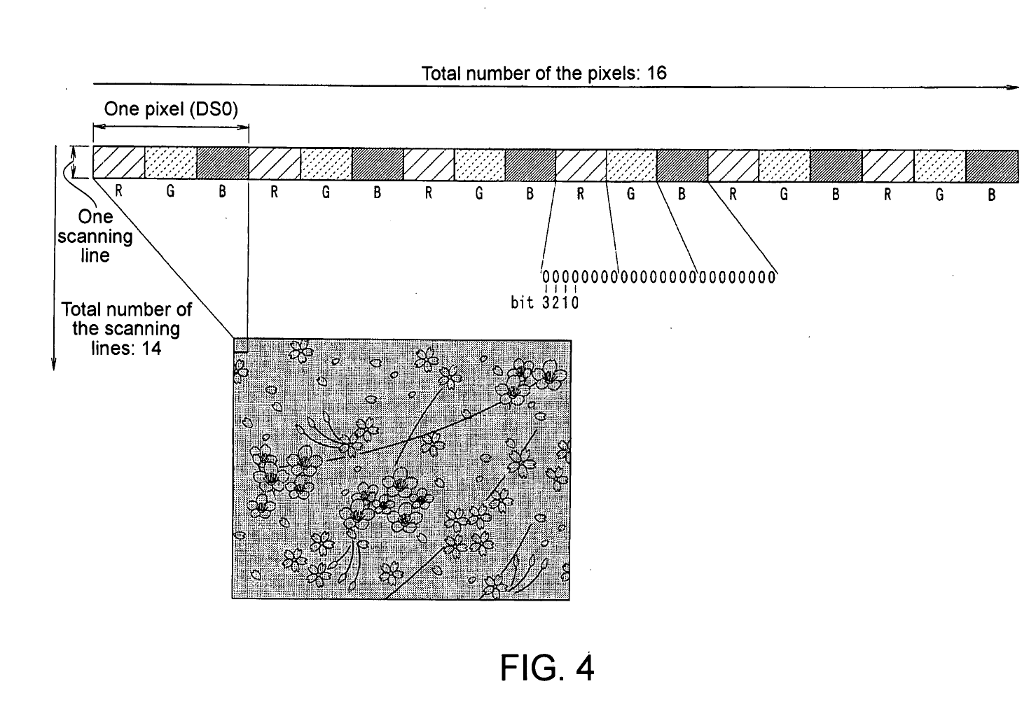

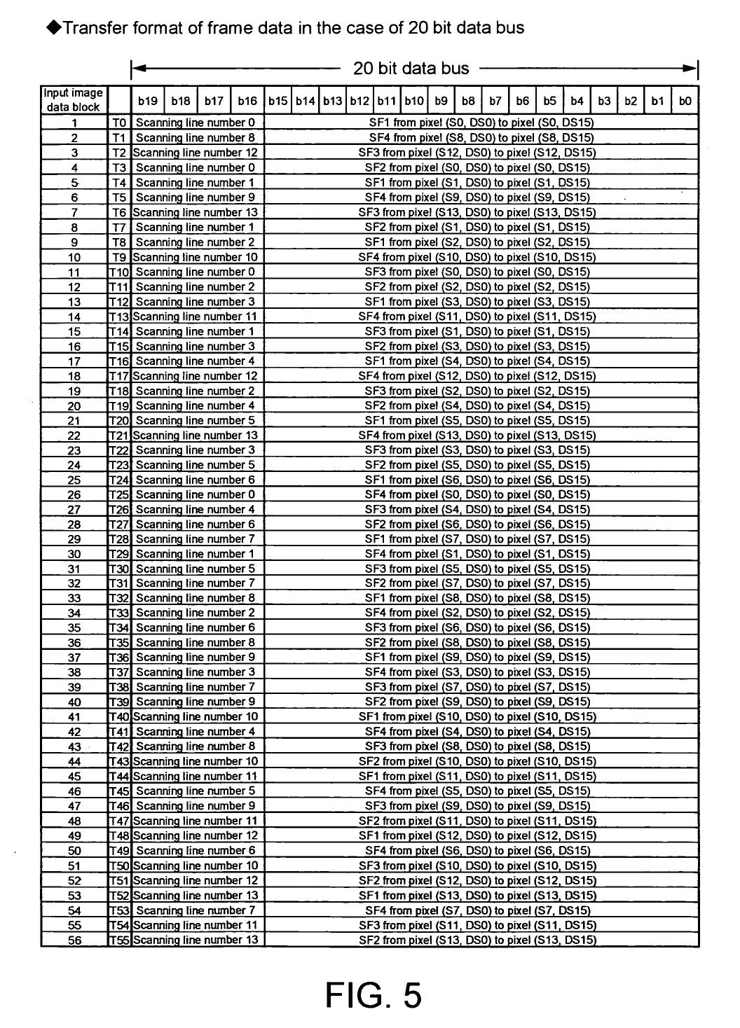

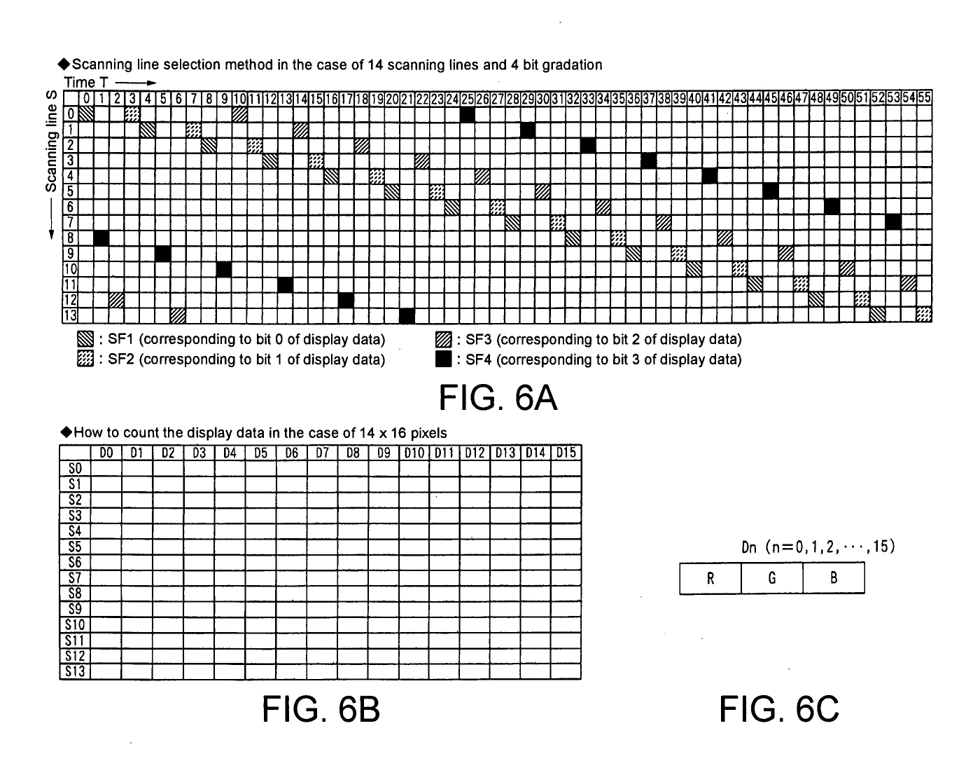

Referring to FIGS. 2 through 6, the operation of the image display system 1 will be described more specifically. FIG. 2 shows a view illustrating a data array for image data to be inputted to the image processing device 10. FIG. 3 shows a view illustrating a data array for the input image data generated in the input image data generation section 10a. FIG. 4 shows a view illustrating the interrelationship between image data and pixel data. FIG. 5 shows a view illustrating the display order of the pixel data after having been rearranged in the input image data generation section 10a. FIG. 6(a) shows a view illustrating a situation of the scanning line being selected in the case that the number of scanning lines of the display area is fourteen lines and the gradation data is four bits. FIG. 6(b) shows a view illustrating the relationship between the scanning lines and the pixels in the panel 11a, and FIG. 6(c) shows a view illustrating a configuration of the pixel data.

At first, when image data such as image data of a moving picture is inputted in the image processing device 10 from a apparatus such as a PC, the image data is stored in the frame memory 10b. As shown in FIG. 2, the pixel data (D0-D15) corresponding to each scanning line of the inputted image data includes of 24-bit gradation data of R (eight bits), G (eight bits), and B (eight bits) for each R, G, and B, representing color data.

Then, when the image data is stored in either one of the two storage regions of the frame memory 10b, the image processing device 10 reads out the image data stored in the frame memory 10b by the input image data generation section 10a, and analyzes the image data. By this analysis, the size and number of colors of the image data are identified. Subsequently, based on the number of scanning lines and the gradation display capability of the display area, obtained from the electro-optic apparatus 11, the pixel data in the image data is rearranged in accordance with the scanning-line selection order of the non-sequential scanning operation, and thus the input image data is generated.

In the present embodiment, generation of the input image data is carried out, assuming the number of scanning lines of the electro-optic apparatus 11 is fourteen, and the gradation display capability is four bits. The image data has eight-bit gradation data for each R, G, and B as pixel data as described above, but the electro-optic apparatus 11 has only a four-bit gradation display capability as described above. In the present embodiment, the input image data is generated by paying attention to the four-bit data of the higher digits (four bits) from the Most Significant Bit (MSB) (the seventh bit) to the fourth bit of the gradation data of each of the eight-bits for the R, G, and B in the image data.

Accordingly, the first pixel data DS0, which has been rearranged based on the scanning-line selection order of non-sequential scanning, becomes the data (binary 0 or 1) corresponding to the bit 0 (here, the fourth bit of the gradation data of each of the eight-bits for the R, G, and B as described above) of the gradation data, as shown in FIG. 3. That is, the first pixel data of DS0 (R, G, B) becomes three bits of DS0 (0, 1, 1) based on the pixel data D0 shown in FIG. 2. Similarly, regarding the pixel data D0, DS0 corresponding to the fifth bit to the seventh bit (the MSB) of the gradation data is rearranged in accordance with the scanning-line selection order of the non-sequential scanning operation. By carrying out such rearrangement of the pixel data D0 through D15 for each scanning line, the input image data for one image is generated. In addition, in the present embodiment, DS0 corresponds to the pixel data at the upper left of the image data, as shown in FIG. 4.

Moreover, if new image data (the next frame in case of moving pictures) is inputted during the generation of the input image data, the image data is written to another storage region, where the image data currently under processing is not being stored. Furthermore, the generated input image data treats the pixel data for each scanning line as one block (sixteen bits of D0 through D15), as shown in FIG. 5, and a number (four bits) designating the scanning line is assigned to each block. Then, the block data for one image, to which the scanning-line number has been assigned, is stored as one binary file by overwriting the storage region of the frame memory 10b, where the not-yet-processed image data has been strored.

Furthermore, upon generation of the input image data for one image, the input image data transmission section 10c carries out a process of transmitting the input image data to the electro-optic apparatus 11. As shown in FIG. 5, the input image data is transmitted for every twenty bits (each block) in accordance with the process time of the electro-optic apparatus. That is, in the binary file, the input image data is transmitted in a sequence of the input image data block 1, the input image data block 2, the input image data block 3, and so on to the input image data block 56.

In the electro-optic apparatus 11, upon acquisition of the input image data block from the image processing device 10 by an input image data acquisition section 11f, the data is stored in one of two storage regions in the frame memory 11e through the control section 11d. Then, upon completion of storing the input image data block for one image (binary file) in either one of the two storage regions of the frame memory 11e, a process of displaying the image of the input image data block on the panel 11a is started by the control section 11d, the scanning-line driving section 11b, and the data-line driving section 11c. The control section 11d reads out the input image data block from the storage region of the frame memory 11e, and extracts the number of the scanning lines to be selected at first. While information is being read out from one of the two storage regions in the frame memory 11e and display processing is being carried out, new data is written to the other storage region. Accordingly, the input image data block is transmitted to the electro-optic apparatus 11 from the image processing device 10 at this time.

Furthermore, the gradation display processing of the image by the non-sequential scanning operation in the electro-optic apparatus 11 will be described with referring to FIGS. 6(a)-(c). A case, in which the number of the scanning lines of the display area on the panel 11a is fourteen lines, the bit length of the gradation data is four bits, and the number of pixels of the display area is 224 (14×16) pixels, will be described as an example. First, a method of determining the selection order of the scanning lines in case of fourteen lines for the total number of scanning lines and four bits for the bit length of the gradation data will be specifically described. In the present embodiment, the determination of the selection order of the scanning lines is carried out as a program by the image processing device 10, that is, carried out by obtaining the total number of the scanning lines and the gradation data from the electro-optic apparatus 11 with the image processing device 10.

At first, a numerical group, obtained by dividing fifteen, obtained by adding one to fourteen, the total number of scanning lines, with the corresponding proportion determined by 2ⁿ values (n=0, 1, 2 through (N−1)) of the number of bits in the bit string constituting the gradation data that has a bit length N, is generated. That is, because the bit length N of the gradation data is four bits, the value fifteen, which is obtained by adding one to fourteen, the total number of scanning lines, is divided corresponding to the ration of 20:21:22:23=1:2:4:8. In this case, it can be divided exactly into 1:2:4:8. Accordingly, it is divided into four numeric values of 1, 2, 4, and 8, according to each ratio.

Next, a serial number ranging from 0 through 13 is assigned to each of the scanning lines with the total number being fourteen. Then, as an initial value, the serial number 0 for the scanning line to be selected first (hereinafter, referred to an initial scanning line) is set to the Least Significant Bit (LSB) (0th bit) of the gradation data. Next, the serial number 8, obtained by adding the largest number 8 among the divided numbers to the serial number 0 of the scanning line that was selected last is set as the serial number of the initial scanning line to the third bit (the MSB) of the gradation data. Furthermore, the serial number 12, obtained by adding the second largest number 4 among the divided numbers to the serial number 8 of the scanning line that was selected last, is set as the serial number of the initial scanning line to the second bit of the gradation data. Furthermore, the third largest number 2 among the divided numbers is added to the serial number 12 of the scanning line that was selected last, but because in this case the number after the addition exceeds the serial number thirteen, the residual (0), obtained when the addition result fourteen is divided by fourteen of the total number of the scanning lines, is assigned as the serial number of the initial scanning line to the first bit of the gradation data. In addition, in case of fifteen, obtained by adding 3 to 12, the serial number of the initial scanning line becomes 1 because 15/14=1 (and a residual of 1).

Accordingly, regarding the four bits of the bit length of the gradation data, the serial number 0 is set as the initial value to the LSB, the serial number 8 is assigned as the initial value to the MSB, the serial number 12 is assigned as the initial value to the second bit, and the serial number 0 is assigned as the initial value to the first bit. Thus, corresponding to the bit length of the gradation data, the serial number of the initial scanning line corresponding to each bit of the gradation data is determined by the numeric value obtained by adding the divided number, from the highest to the lowest, to the serial number of the scanning line that has been selected last, as described above.

Furthermore, as for the determined initial scanning lines, each of the scanning lines corresponding to a serial number is selected from the initial scanning line corresponding to the LSB (0th bit), the initial scanning line corresponding to the MSB (third bit), the initial scanning line corresponding to the second bit, and the initial scanning line corresponding to the first bit of the gradation data, and then each pixel of the selected scanning line is driven. Then, after the selection of each scanning line, one is added to each serial number of the initial scanning line corresponding to each bit. In this case, if the result of having added one to the initial value corresponding to each bit exceeds the value (thirteen in this case), obtained by subtracting one from the total number of scanning lines, the addition result is set to zero. That is, when the thirteenth scanning line is selected and one is added to the serial number 13, the addition result is set to zero, which is the smallest value for the serial number of the scanning line, instead of adopting the addition result of the numeric value (fourteen) that exceeds the serial number 13 of the scanning line. Therefore, the 0th scanning line is selected in the next process. The selection order of each bit of the gradation data is conducted in a sequence of the LSB, the MSB, “the highest order bit between the LSB and the MSB, the lowest order bit”, the LSB, the MSB, and so on. That is, a cycle of the 0th bit, the third bit, the second bit, the first bit, the 0th bit, the third bit, the second bit, and so on. That is, when the 0th scanning line, the eighth scanning line, the twelfth scanning line, and the 0th scanning line are selected corresponding to each bit of the gradation data, the scanning line, having the serial number obtained by adding one to the serial number of the scanning line that has been selected last corresponding to each bit, is sequentially selected, such that the first scanning line, the ninth scanning line, the thirteenth scanning line, and the first scanning line are selected, and each pixel is driven.

That is, as shown in FIG. 6(a), corresponding to each bit of the gradation data, the scanning line in the non-sequential scanning operation is selected in a sequence of the 0th scanning-line, the eighth scanning-line, the twelfth scanning-line, 0th scanning-line and so on. Furthermore, if the display area is represented by the number of scanning lines designated as S0 through S13, and the pixels corresponding to each scanning line designated as D0 through D15, like the above-described serial number, the number of pixels per scanning line becomes sixteen pixels as shown in FIG. 6(b). Moreover, regarding the pixel information corresponding to each pixel, the color information based on R, G, and B corresponding to each gradation is provided, and three of the bits of data of R, G, and B for each gradation bit correspond to each pixel D0 through D15 as shown in FIG. 6(c).

Accordingly, in order to carry out the above-described non-sequential scanning operation, the input image data is rearranged for each data block in the order shown in FIG. 5 in the image processing device 10, and is transmitted to the electro-optic apparatus 11. The pixels, DS0 through DS15, for one block in the n-th scanning line Sn (n=0, 1, 2 through 13) are designated as (Sn, DS0) through (Sn, DS15). Moreover, because the gradation data is composed of four bits, each scanning line is selected for each bit of the gradation data. That is, while one image is being displayed by graduation, each scanning line is selected four times. When paying attention on the scanning line S0, the scanning line S0 is selected first at T0 (corresponding to bit 0 (the LSB) of the gradation data), second at T3 (corresponding to bit 1 of the gradation data), third at T10 (corresponding to bit 2 of the gradation data), and fourth at T25 (corresponding to bit 3 (the MSB) of the gradation data). The time interval thereof by examination turns out three for T0 to T3, seven for T3 to T10, and fifteen for T10 to T25. That is, it is understood that the light emission is carried out by the ratio of 3:7:15 such that the interval from the first light emission to the second light emission is two, three for the third light emission and fifteen for the fourth light emission.

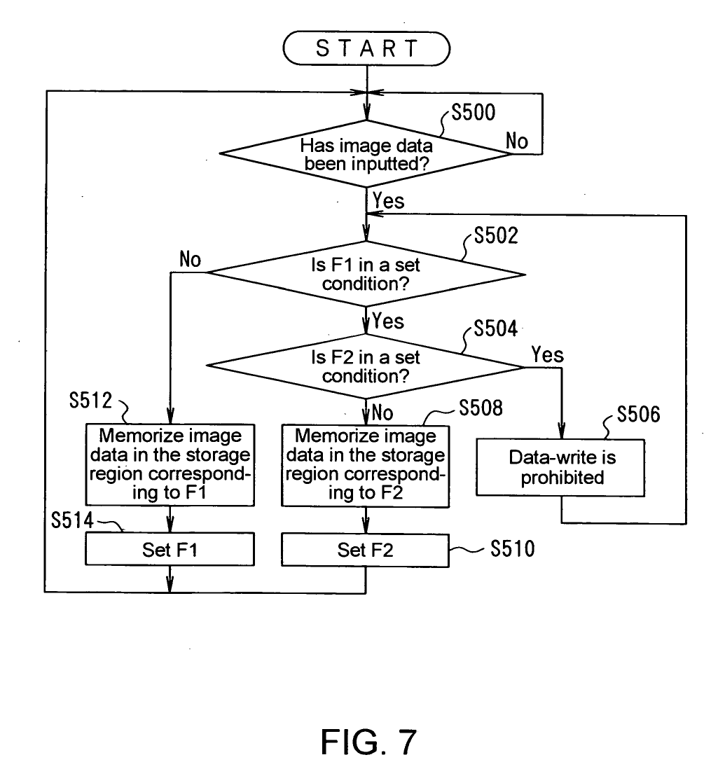

In addition, in the present embodiment, as shown in FIG. 5, the input image data (sixteen bits) is transmitted along with the number information of the scanning line (four bits) to the electro-optic apparatus 11 through a 20-bit data bus. Furthermore, the flow of the acquisition process of the image data in the image processing device 10 will be described with referring to FIG. 7. FIG. 7 is a flow chart showing the acquisition process of image data in the image processing device 10.

As shown in FIG. 7, at Step S500 whether the image data has been obtained or not from the external device such as a PC is judged. If judged as the image data having been obtained (Yes), the flow proceeds to Step S502, and if not (No), waits till the image data has been obtained. In the case of having proceeded to Step S502, whether F1, which is the flag corresponding to the storage region 1 of the frame memory 10b, is in a set condition (condition of 1 being set in a specified register) or not is judged, and if judged as being in the set condition (Yes), it proceeds to Step S504, and if not (No), it proceeds to Step S512.

As for the present embodiment, when F1 is in the set condition, not-yet-processed image data is stored in the storage region 1 of the frame memory 10b, and when F1 is in a cleared condition (condition of 0 being set to the specified register), processed image data is stored, nothing is stored, or the image data is written in the storage region 1 of the frame memory 10b.

In case of having proceeded to Step S504, whether F2, which is a flag corresponding to the storage region 2 of the frame memory 10b, is in the set condition (condition of 1 being set to the specified register) or not, is judged, and if judged as being in the set condition (Yes), it proceeds to Step S506, and if not (No), it proceeds to Step S508. As for the present embodiment, like F1, when F2 is in the set condition, not-yet-processed image data is stored in the storage region 2 of the frame memory 10b, and when F2 is in a cleared condition (condition of 0 being set to the specified register), processed image data is stored, nothing is stored, or the image data is written in the storage region 2 of the frame memory 10b.

In case of having proceeded to Step S506, data-write to the frame memory 10b is prohibited, and it proceeds to Step S502. That is, it is a state that not-yet-processed image data is stored in both the storage region 1 and the storage region 2 of the frame memory 10b, and the processings of Step S502 through Step S506 are repeated until either one of them has been processed.

On the other hand, in case of having proceeded to Step S508, the inputted image data is stored in the storage region 2 corresponding to F2, and it proceeds to Step S510. At Step S510, the flag F2 corresponding to the storage region 2 of the frame memory 10b is set, and it proceeds to Step S500. Moreover, when F1 is in the cleared condition at Step S502 and it proceeds to Step S512, the inputted image data is stored in the storage region 1 corresponding to F1, and it proceeds to Step S514.

At Step S514, the flag F1 corresponding to the storage region 1 of the frame memory 10b is set, and it proceeds to Step S500. That is, when image data is inputted, whether the flag is set to the storage region of the frame memory 10b or not is judged, and the image data is stored in the storage region where the flag was not been set. Thus, even if the flag of one of the storage regions is in the set condition due to the generation process or the like of the input image data, the image data can be stored if the flag of the other storage region is not in the set condition.

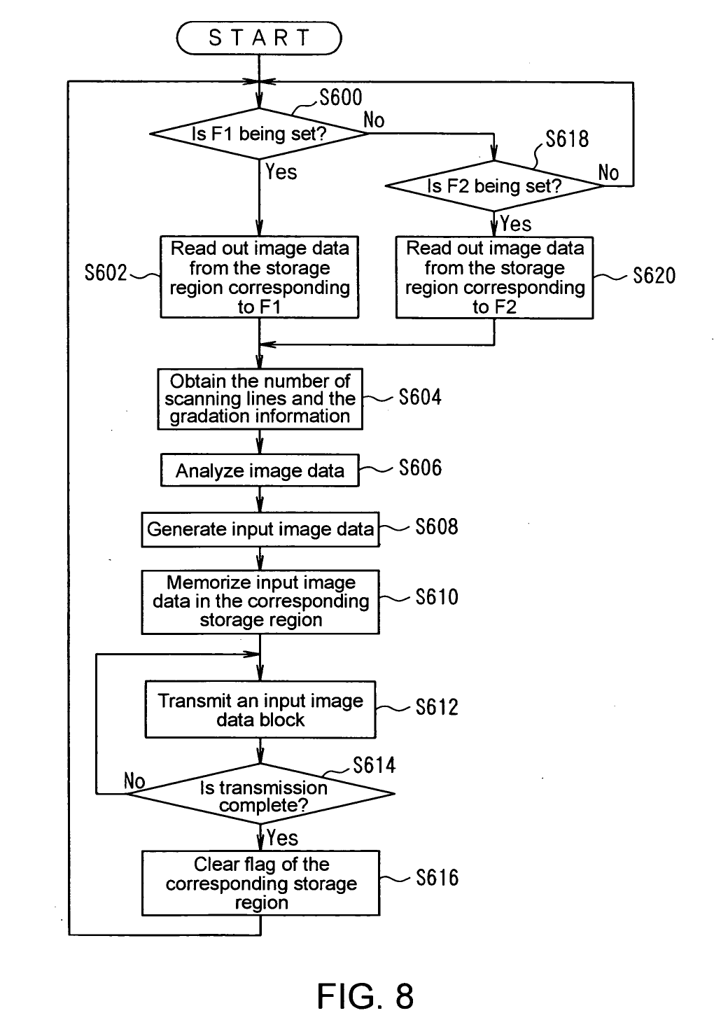

Furthermore, with referring to FIG. 8, a flow of the generation process of the input image data and the transmission process of the input image data in the image processing device 10 will be described. FIG. 8 is a flow chart showing the generation process of the input image data and the transmission process of the input image data in the image processing device 10. As shown in FIG. 8, at S600, whether the flag F1 corresponding to the storage region 1 of the frame memory 10b has been set or not in the input image data generation section 10a is judged. If judged as having been set (Yes), it proceeds to Step S602, and if not (No), it proceeds to Step S618.

In case of having proceeded to Step S602, the image data is read out from the storage region 1 of the frame memory 10b corresponding to the flag F1, and it proceeds to Step S604. At Step S604, after having obtained the number of the scanning lines and the gradation information of the display area from the electro-optic apparatus 11 through the input image data transmission section 10c, it proceeds to Step S606. The number of the scanning lines and the gradation information are obtained by assuming that the display area and the number of the gradation are variable by the electro-optic apparatus 11, therefore if these values are fixed, they may be obtained at the beginning or this information may be inputted in advance.

At Step S606, in the input image data generation section 10a, the obtained image data is analyzed, and it proceeds to Step S608. In the analysis of the image, the size (the number of pixels) and the number of colors of the image are analyzed. At Step S608, in the input image data generation section 10a, based on the number of the scanning lines and the gradation information of the electro-optic apparatus, the pixel data in the image data is rearranged to generate the input image data, and then it proceeds to Step S610.

At Step S610, the generated input image data is stored in the storage region from which the image data is read out, and it proceeds to Step S612. At Step S612, in the input image data transmission section 10c, the input image data block corresponding to the selection number of the scanning lines in the non-sequential scanning operation, which has not been transmitted, is read out from the storage region where the input image data is stored, and is transmitted to the electro-optic apparatus 11, and then it proceeds to Step S614.

At Step S614, whether transmission of the generated input image data is complete or not is judged, and if judged as being complete (Yes), it proceeds to Step S616, and if not (No), it proceeds to Step S612. In case of having proceeded to Step S616, the flag corresponding to the storage region, where the input image data after transmission is stored, is cleared, and then it proceeds to Step S600.

Moreover, when the flag F1 has not been set at Step S600 and it proceeds to Step S618, whether the flag F2 has been set or not in the input image data generation section 10a is judged, and if judged as having been set (Yes), it proceeds to Step S620, and if not (No), it proceeds to Step S600.

In case of having proceeded to Step S620, the image data is read out from the storage region 2 of the frame memory 10b corresponding to the flag F2, and then it proceeds to Step S604. That is, by carrying out the process of Step S600 through Step S620, it is possible: to read out the image data from the storage region, where the flag corresponding to the storage region of the frame memory 10b is in the set condition; to generate the input image data by rearranging the pixel data based on the selection order of the scanning lines in the non-sequential scanning operation; and to transmit the generated input image data to the image display device 11 for each data block having a predetermined size.

Then, because the flag of the storage region is reset after having completed the transmission process of the input image data from the selected storage region, the image data can be written to the storage region in the process of the above-described Step S500 through Step S514. That is, because the flag is in the set condition during generation or transmission of the input image data, in the process of the above-described Step S500 through Step S514, the image data cannot be written to the storage region. However, while the generation or the transmission of the input image data is being carried out in one of the storage regions, it is possible to carry out the write process of the image to the other storage region, where the flag is being reset.

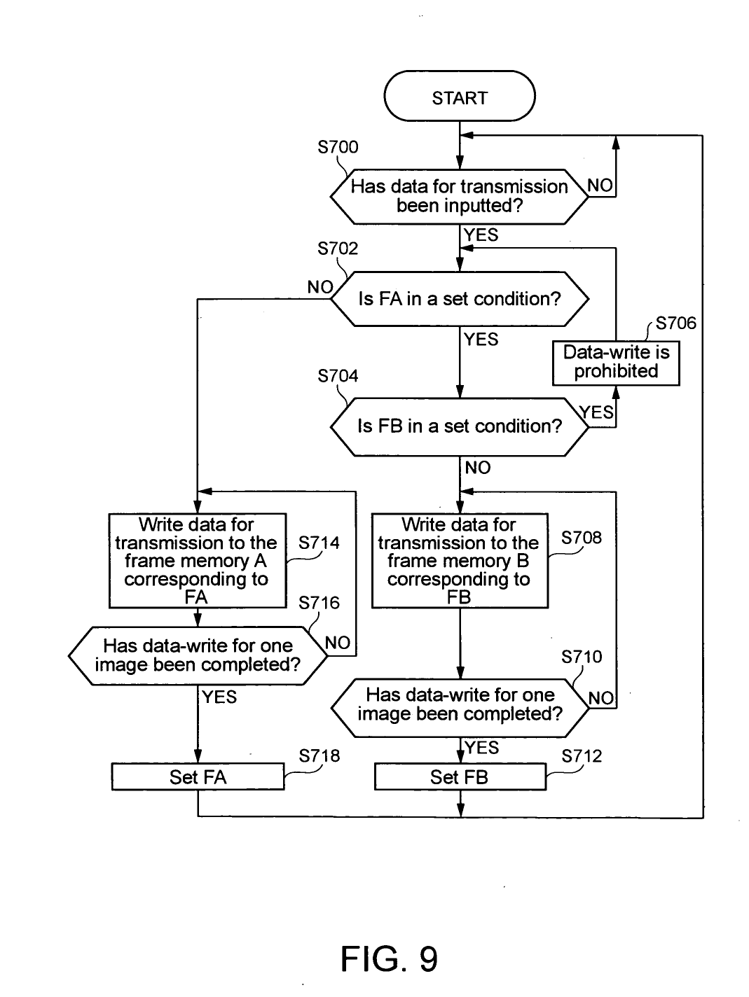

Accordingly, the write process of the image data and the read-out process (transmission process) of the image data to the storage region 1 and the storage region 2 of the frame memory 10b are alternately carried out to each region, when the image data is being sent consecutively. Furthermore, with referring to FIG. 9, a flow of the write process of input image data in the frame memory lie in the electro-optic apparatus 11 will be described. FIG. 9 is a flow chart showing the write process of input image data in the frame memory 11e in the electro-optic apparatus 11.

As shown in FIG. 9, at Step S700, whether the input image data block has been inputted or not from the image processing device 10 is judged in the control section 11d, and if judged as having been inputted (Yes), it proceeds to Step S702, and if not (No), it waits until the data has been inputted. In case of having proceeded to Step S702, whether a flag FA corresponding to a frame memory A is in the set condition (condition of 1 being set to the specified register) or not is judged in the control section 11d, and if judged as being in the set condition, (Yes), it proceeds to Step S704, and if not (No), it proceeds to Step S714.

As for the present embodiment, when FA is in the set condition, not-yet-processed image data is stored in the frame memory A of the frame memory 11e, and when FA is in the cleared condition (condition of 0 being set to the specified register), processed image data is stored, or nothing is stored, or image data is written in the frame memory A of the frame memory 11e.

In case of having proceeded to Step S704, whether a flag FB corresponding to a frame memory B is in the set condition (condition of 1 being set to the specified register) or not is judged in the control section 11d, and if judged as being in the set condition (Yes), it proceeds to Step S706, and if not (No), it proceeds to Step S708.

As for the present embodiment, like FA, when FB is in the set condition, not-yet-processed image data is stored in the frame memory B of the frame memory 11e, and when FB is in the cleared condition (condition of 0 being set to the specified register), processed image data is stored, or nothing is stored, or image data is written in the frame memory B of the frame memory 11e.

In case of having proceeded to Step S706, data-write to the frame memory 11e is prohibited in the control section 11d, and then it proceeds to Step S702. On the other hand, in case of having proceeded to Step S708, the control section 11d writes the input image data block in the frame memory B corresponding to the flag FB, and then it proceeds to Step S710.

At Step S710, whether writing one image data in the frame memory B has been completed or not is judged, and if judged as having been completed (Yes), it proceeds to Step S712, and if not (No), it proceeds to Step S708. In case of having proceeded to Step S712, the control section 11d sets the flag FB, and it proceeds to Step S700.

Moreover, at Step S702, when the flag FA is not in the set condition and it proceeds to Step S714, the control section 11d writes the input image data block to the frame memory A corresponding to the flag FA, and it proceeds to Step S716. At Step S716, whether writing one image data to the frame memory A has been completed or not is judged, and if judged as having been completed (Yes), it proceeds to Step S718, and if not (No), it proceeds to Step S714.

In case of having proceeded to Step S718, the control section 11d sets the flag FA, and it proceeds to Step S700. That is, with process of the above-described Step S700 through Step S718, whether the flag FA or flag FB has been set or not is judged, and data is not written to the frame memory where the flag has been set, but is written to the frame memory where the flag has not been set.

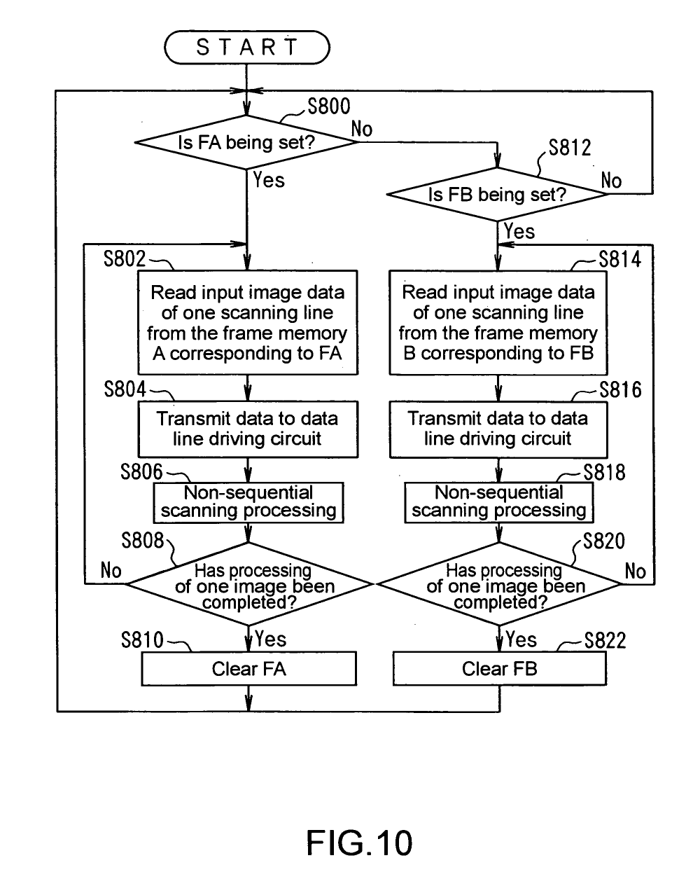

Furthermore, with referring to FIG. 10, a flow of the display process of the image by the non-sequential scanning operation in the electro-optic apparatus 11 will be described. FIG. 10 is a flow chart showing the display process of the image in the non-sequential scanning operation in the electro-optic apparatus 11. As shown in FIG. 10, at Step S800, the control section 11d judges whether the flag FA corresponding to the frame memory A has been set or not. If judged as being set (Yes), it proceeds to Step S802, and if not (No), it proceeds to Step S812.

In case of having proceeded to Step S802, the control section 11d reads out the input image data block, which has been written to the frame memory A in the frame memory 11e, with a predetermined order, and it proceeds to Step S804. At Step S804, the control section 11d transmits the read-out input image data block to the data-line driving section 11c, and it proceeds to Step S806.

At Step S806, based on the read-out input image data block, the control section 11d controls the scanning-line driving section 11b and the data-line driving section 11c, and carries out the gradation display process of the image by the non-sequential scanning operation, and it proceeds to Step S808. At Step S808, the control section 11d judges whether the processing of one image has been completed or not, and if judged as having been completed (Yes), it proceeds to Step S810, and if not (No), it proceeds to Step S802.

At Step S810, the control section 11d clears the flag FA corresponding to the frame memory A, and it proceeds to Step S800. On the other hand, in case of having proceeded to Step S812, whether the flag FB corresponding to the frame memory B has been set or not is judged. If judged as being in the set condition (Yes), it proceeds to Step S814, and if not (No), it proceeds to Step S800.

In case of having proceeded to Step S814, the control section 11d reads out the input image data block, which has been written to the frame memory B in the frame memory 11e, and it proceeds to Step S816. At Step S816, the control section 11d transmits the read-out input image data block to the data-line driving section 11c, and it proceeds to Step S818.

At Step S818, based on the read-out input image data block, the control section 11d controls the scanning-line driving section 11b and the data-line driving section 11c, and carries out the gradation display process of the image by the non-sequential scanning operation, and it proceeds to Step S820. At Step S820, the control section 11d judges whether the processing of one image has been completed or not, and if judged as having been completed (Yes), it proceeds to Step S822, and if not (No), it proceeds to Step S814.

At Step S822, the control section 11d clears the flag FB corresponding to the frame memory B, and it proceeds to Step S800. That is, by repeating the processes of Step S800 through Step S822, the input image data block is read out from the storage region where either flag FA or FB corresponding to the frame memory A or the frame memory B, which are the storage regions of the frame memory 11e, is in the set condition, and based on the scanning-line number contained in the input image data block, the scanning-line driving section 11b is driven, and the pixel circuit, corresponding to the scanning line selected by driving the data line driving section 11c, is driven, thereby carrying out the gradation display of the image.

Then, because the flag of the storage region is reset after having completed the transmission process of the input image data from the selected storage region, the input image data can be written to the storage region at the processes of the above-described Step S700 through Step S718. That is, because the flag is in the set condition while the input image data block is being read-out, in the process of the above-described Step S700 through Step S718, the input image data block cannot be written to the storage region. However, while the input image data block is being read-out in one of the storage regions, it is possible to carry out the write process of the input image data block to the other storage region, where the flag has been reset.

Accordingly, the write and the read-out process of the input image data block to the frame memory A and the frame memory B in the frame memory lie are alternately carried out to each region, when the image data is being sent consecutively. In the above-described first embodiment, because the image data is transmitted to the electro-optic apparatus 11 after the image data has been rearranged based on the selection order of the scanning lines in the non-sequential scanning operation in advance by the image processing device 10, the extraction process of the image data corresponding to the non-sequential scanning operation is not required by the electro-optic apparatus 11.

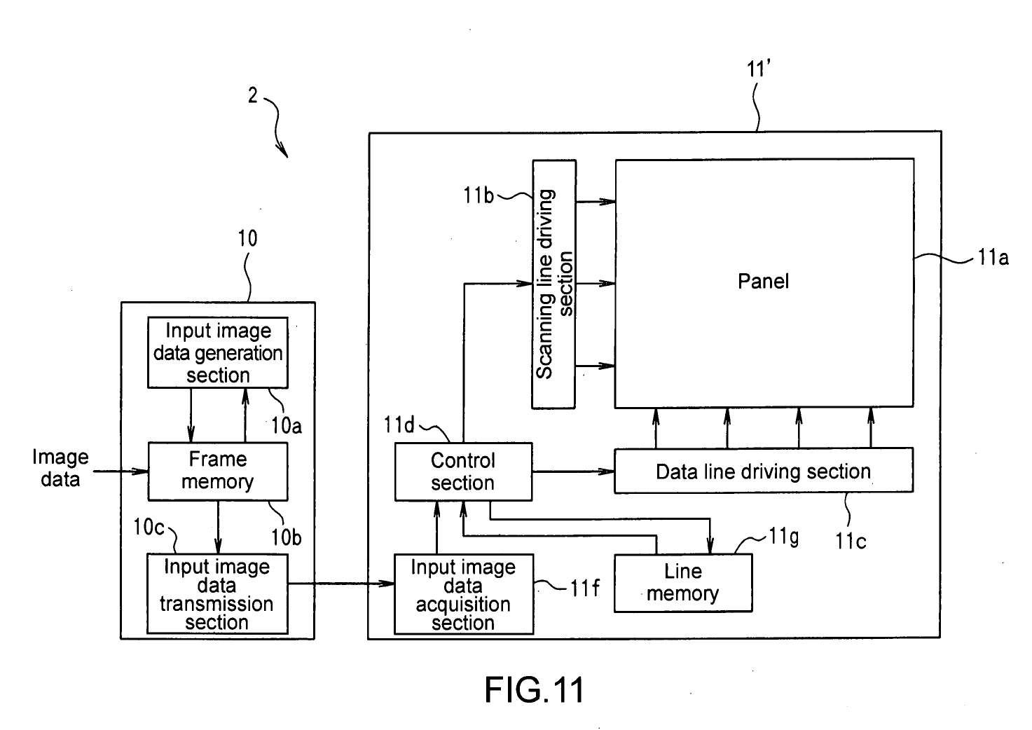

Furthermore, with referring to FIG. 11, the configuration of an image display system 2 according to a second embodiment of the present invention will be described. FIG. 11 shows a block diagram illustrating the configuration of the image display system 2 according to the second embodiment of the present invention. The image display system 2 includes the image processing device 10 and an electro-optic apparatus 11′.

The image processing device 10 includes the input image data generation section 10a, the frame memory 10b and an input image data transmission section 10c. Regarding the same sections as the image display system 1 in the above-described first embodiment, the same symbols are given, and the description of the operation of these sections that are not different will be omitted. The input image data generation section 10a carries out the processing of image data, obtained from an apparatus such as a PC, to generate input image data which is rearranged according to the selection order of the scanning lines in the image display by the non-sequential scanning operation in the electro-optic apparatus 11′. The generated input image data is transmitted to the electro-optic apparatus 11′ per one input image data block, every time the rearrangement of the pixel data (input image data block) of one scanning line is complete.

The input image data transmission section 10c transmits the input image data block, generated in the input image data generation section 10a, to the electro-optic apparatus 11′, every time the input image data block is generated. The electro-optic apparatus 11′ includes the panel 11a, the scanning-line driving section 11b, the data-line driving section 11c, the control sections 11d, a line memory 11g, and the input image data acquisition section 11f.

The control section 11d makes the scanning-line driving section 11b select the scanning line of the image display area on the panel 11a in a specific order by the non-sequential scanning operation, and drives the pixel circuit corresponding to the selected scanning line by providing the data signal to the data-line driving section 11c based on the image data to be displayed. As for the present embodiment, every time processing of writing the input image data block to one of the two storage regions in the line memory 11g is carried out, the control section 11d makes the scanning-line driving section 11b read out the input image data block, which has been stored in the other storage region, selects the scanning line based on the selection order of the scanning lines contained in the input image data block, and drives the pixel circuit corresponding to the selected scanning line by providing the data signal to the data-line driving section 11c based on the image data to be displayed.

The line memory 11g, a memory for storing the input image data block from the image processing device 10, includes two storage regions in order to write data and read out data simultaneously. The input image data acquisition section 11f obtains the input image data block from the image processing device 10 at each predetermined time. The obtained input image data block is stored in the line memory 11g through the control section 11d.

That is, as for the different point from the image display system 1 of the first embodiment, the image display system 2 of the second embodiment transmits the pixel data to the electro-optic apparatus 11′ sequentially every time rearrangement of the pixel data (input image data block) of one scanning line of one image data has been completed even if rearrangement of the pixel data for one image data has not been completed at all in the input image data generation section 10a. Furthermore, the electro-optic apparatus 11′ includes the line memory 11g instead of the frame memory 11e in the electro-optic apparatus 11 of the first embodiment. As described above, the line memory 11g has two storage regions with a capacity that can store the input image data block, which is the pixel data for one scanning line. Then, every time processing of writing the input image data block to one of the two storage regions in the line memory 11g is carried out, the control section 11d makes the scanning-line driving section 11b read out the input image data block stored in the other storage region and carry out the above-described process, thereby carrying out the gradation display processing by the non-sequential scanning operation.

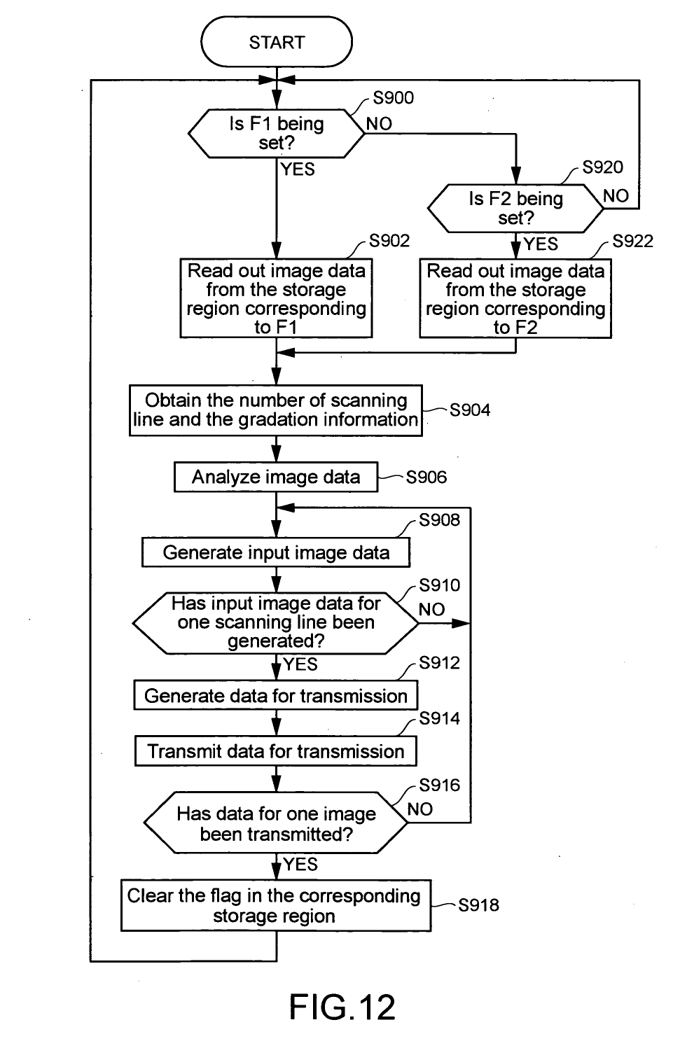

Furthermore, referring to FIG. 12, a flow of the generation process of the input image data and the transmission process of an input image data in the image processing device 10 according to the second embodiment will be described. FIG. 12 is a flow chart showing the generation process of the input image data and the transmission process of the input image data in the image processing device 10. The description about the acquisition process of the image data in the image processing device 10 will be omitted, because the process is the same as the above-described first embodiment.

As shown in FIG. 12, at Step S900 whether the flag F1 corresponding to the storage region 1 of the frame memory 10b has been set or not in the input image data generation section 10a is judged. If judged as having been set (Yes), it proceeds to Step S902, and if not (No), it proceeds to Step S920. In case of having proceeded to Step S902, the image data is read out from the storage region 1 of the frame memory 10b corresponding to the flag F1, and then it proceeds to Step S904.

At Step S904, after having obtained the number of the scanning lines and the gradation information on the display area from the electro-optic apparatus 11′ through the input image data transmission section 10c, it proceeds to Step S906. The number of the scanning lines and the gradation information are obtained by assuming that the display area and the number of the gradation are variable at the electro-optic apparatus 11′. Therefore, if these values are fixed, they may be obtained at the beginning or this information may be inputted in advance.

At Step S906, in the input image data generation section 10a, the obtained image data is analyzed, and it proceeds to Step S908. In the analysis of the image, the size (the number of pixels) and the number of colors of the image are analyzed. At Step S908, in the input image data generation section 10a, based on the number of scanning lines and the gradation information of the electro-optic apparatus, rearrangement of the pixel data in the image data and the generation of the input image data are carried out, and then it proceeds to Step S910.

At Step S910, in the input image data generation section 10a, whether the input image data for one scanning line has been generated or not is judged. If judged as having been generated (Yes), it proceeds to Step S912, and if not (No), then it proceeds to Step S908. In the case of having proceeded to Step S912, data for transmission, which is the input image data for one scanning line, to which the scanning-line number has been assigned, are generated, and then it proceeds to Step S914.

At Step S914, the generated data for transmission are transmitted to the electro-optic apparatus 11′, and it proceeds to Step S916. At Step S916, whether transmission of the generated input image data for one image is complete or not is judged, and if judged as being complete (Yes), it proceeds to Step S918, and if not (No), it proceeds to Step S908.

In case of having proceeded to Step S918, the flag corresponding to the storage region, where the input image data after transmission has been stored, is cleared, and then it proceeds to Step S900. Moreover, when the flag F1 has not been set at Step S900 and it proceeds to Step S920, whether the flag F2 has been set or not is judged in the input image data generation section 10a, and if judged as being set (Yes), it proceeds to Step S922, and if not (No), it proceeds to Step S900.

In case of having proceeded to Step S922, the image data is read out from the storage region 2 of the frame memory 10b corresponding to the flag F2, and then it proceeds to Step S904. That is, by carrying out the process of Step S900 through Step S922, it is possible: to read out the image data from the storage region, where the flag corresponding to the storage region of the frame memory 10b is in the set condition; generate the input image data by rearranging the pixel data according to the selection order of the scanning lines in the non-sequential scanning operation; and transmit the data to the electro-optic apparatus 11′ every time the input image data of one scanning line is generated.

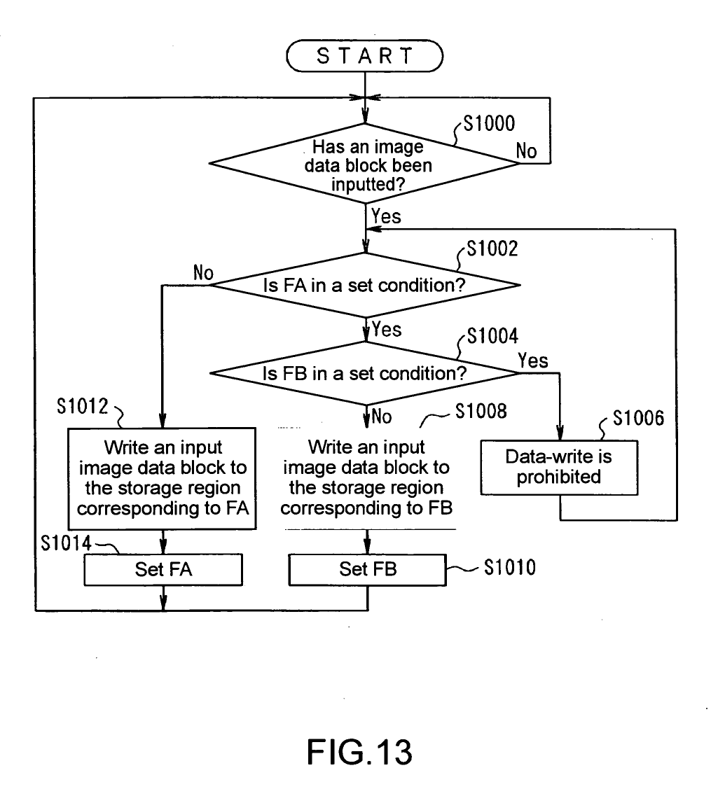

Furthermore, with referring to FIG. 13, the flow of the write processing of the input image data to the line memory 11g in the electro-optic apparatus 11′ according to the second embodiment will be described. FIG. 13 is a flow chart showing the write processing of the input image data to the line memory 11g in the electro-optic apparatus 11′. Each of the two storage regions of the line memory 11g is referred to as line memory A and line memory B.

As shown in FIG. 13, at Step S1000, whether the input image data block has been inputted or not from the image processing device 10 is judged in the control section 11d. If judged as having been inputted (Yes), it proceeds to Step S1002, and if not (No), it waits until the input image data block has been inputted. In case of having proceeded to Step S1002, whether a flag FA corresponding to the line memory A is in the set condition (condition of 1 being set to the specified register) or not is judged in the control section 11d, and if judged as being in the set condition (Yes), it proceeds to Step S1004, and if not (No), it proceeds to Step S1012.

As for the present embodiment, when FA is in the set condition, not-yet-processed image data is stored in the line memory A of the line memory 11g, and when FA is in the cleared condition (condition of 0 being set to the specified register), processed image data is stored, or nothing is stored, or image data is written in the line memory A of the line memory 11g.

In case of having proceeded to Step S1004, whether a flag FB corresponding to the line memory B is in the set condition (condition of 1 being set to a specified register) or not is judged in the control section 11d, and if judged as being in the set condition (Yes), it proceeds to Step S1006, and if not (No), it proceeds to Step S1008.

As for the present embodiment, like the FA, when FB is in the set condition, not-yet-processed image data is stored in the line memory B of the line frame memory 11g, and when FB is in the cleared condition (condition of 0 being set to the specified register), processed image data is stored, or nothing is stored, or image data is written in the line memory B of the line memory 11g.

In case of having proceeded to Step S1006, writing data to the frame memory 11g is prohibited in the control section 11d, and then it proceeds to Step S1002. On the other hand, in case of having proceeded to Step S1008, the control section 11d writes the input image data block to the line memory B corresponding to the flag FB, and then it proceeds to Step S1010.

In case of having proceeded to Step S1010, the control section 11d sets the flag FB, and it proceeds to Step S1000. Moreover, at Step S1002, when the flag FA is not in the set condition and it proceeds to Step S1012, the control section 11d writes the input image data block to the line memory A corresponding to the flag FA, and it proceeds to Step S1014.

At Step S1014, the control section 11d sets the flag FA, and it proceeds to Step S1000. That is, with the processes of the above-described Step S1000 through Step S1014, whether the flag FA or flag FB has been set or not is judged, and data is not written to the frame memory where the flag has been set, but is written to the frame memory where the flag has not been set.

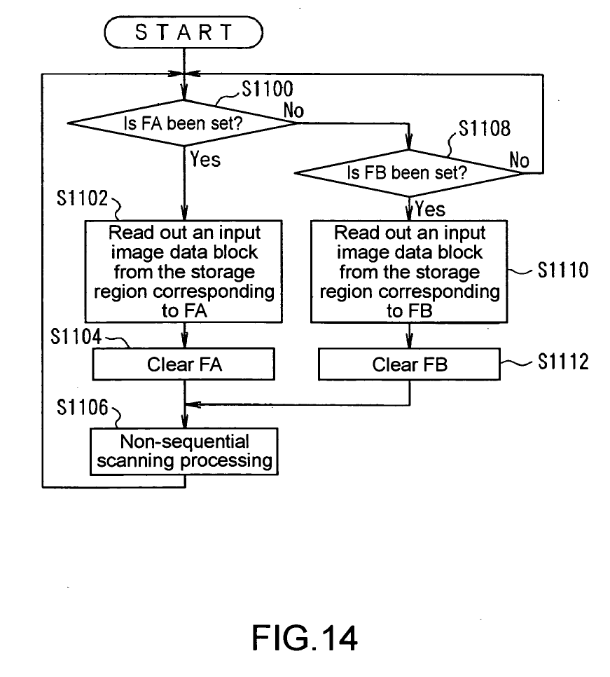

Furthermore, referring to FIG. 14, a flow of a display process of the image by the non-sequential scanning operation in the electro-optic apparatus 11′ will be described. FIG. 14 is the flow chart showing the display process of the image by the non-sequential scanning operation in the electro-optic apparatus 11′. As shown in FIG. 14, at Step S1000, the control section 11d judges whether the flag FA corresponding to the line memory A has been set or not. If judged as been set (Yes), it proceeds to Step S1102, and if not (No), it proceeds to Step S1108.

In case of having proceeded to Step S1102, the control section 11d reads out the input image data block, which has been written to the line memory A in the line memory 11g, and it proceeds to Step S1104. At Step S1104, the control section 11d clears the flag FA corresponding to the line memory A, and it proceeds to Step S1106.

At Step S1106, based on the read-out input image data block, the control section 11d controls the scanning-line driving section 11b and the data-line driving section 11c, and carries out the gradation display process of the image by the non-sequential scanning operation, and it proceeds to Step S1100. On the other hand, in case of having proceeded to Step S1108, whether the flag FB corresponding to the line memory B has been set or not is judged. If judged as being in the set condition (Yes), it proceeds to Step S1110, and if not (No), it proceeds to Step S1100.

In case of having proceeded to Step S1110, the control section 11d reads out the input image data block, which has been written to the line memory B in the line memory 11g, and it proceeds to Step S1112. At Step S1112, the control section 11d clears the flag FB corresponding to the line memory B, and it proceeds to Step S1106.

That is, by repeating the process of Step S1100 through Step S1112, the input image data block is read out from the storage region, where either flag FA or FB corresponding to the line memory A or the line memory B, which are the storage regions of the line memory 11g, is in the set condition, and based on the scanning-line number contained in the input image data block, the scanning-line driving section 11b is driven, and the pixel circuit, corresponding to the scanning line selected by driving the data line driving section 11c, is driven, thereby carrying out the gradation display of the image.

Then, because the flag of the storage region is reset after having completed the read-out process of the input image data from the selected storage region, the image data can be written to the storage region at the process of the above-described Step S1000 through Step S1014. That is, because the flag is in the set condition while the input image data block is being read-out, in the process of the above-described Step S1000 through Step S1014, the input image data block cannot be written to the storage region. However, while the input image data block is being read-out in one of the storage regions, it is possible to carry out the write process of the input image data block to the other storage region where the flag has been reset.

Accordingly, the write and the read out process of the input image data block in the line memory A and the line memory B in the line memory 11g are simultaneously carried out to each region for the input image block to be sent consecutively. As mentioned above, in the input image data generation section 10a, the pixel data is rearranged based on the scanning-line selection order in the non-sequential scanning operation, and every time the rearrangement of the pixel data of one scanning line is complete, the input image data of the one scanning line is transmitted from the image processing device 10 to the electro-optic apparatus 11′. For this reason, the non-sequential scanning operation for each input image data of one scanning line can be carried out by the electro-optic apparatus 11′.

What is claimed is:

1. An image display system, comprising:
an image precessing device; and
an electro-optic apparatus, comprising:
a pixel matrix, where pixels including optical elements are arranged in a matrix shape;
a plurality of scanning lines coupled to a pixel group arranged along either one of a row direction or a column direction of the pixel matrix;
a plurality of data lines coupled to the pixel group arranged along either one of the row direction or the column direction of the pixel matrix;
a scanning-line driving circuit that sequentially selects the plurality of scanning lines one by one;
a data-line driving circuit that outputs a control signal related to light emission of the optical elements to, at least, one data line of the plurality of data lines;
a control section that controls an operation of the scanning-line driving circuit and the data-line driving circuit; and
an input image data acquisition section that obtains input image data transmitted from the image processing device,
wherein the image processing device generates the input image data to be inputted into the electro-optic apparatus and transmits the input image data to the electro-optic apparatus, and
wherein the control section that controls the light emission time of the optical elements by a non-sequential scanning operation that selects a scanning line in a discontinuous order against an arranged order of the scanning lines, based on gradation data of a predetermined bit length corresponding to the input image data and a number of light emission gradation of the optical elements, and gradationally displays an input image on a display area defined by a predetermined number of the scanning lines and the data lines.

2. The image display system according to claim 1, wherein a predetermined amount of pixel data, with a rearrangement that has been completed, is transmitted to the electro-optic apparatus every time the rearrangement has been completed.

3. The image display system according to claim 1, wherein the image processing device comprises:
an input image data generation section;
a frame memory; and
an input image data transmission section.

4. The image display system according to claim 3, wherein the input image data generation section carries out image processing obtained from a personal computer to generation the input image data.

5. The image display system according to claim 4, wherein the input image data is rearranged according a selection order of the scanning lines by the non-sequential scanning operation in the electro-optic apparatus.

6. The image display system according to claim 3, wherein the frame memory includes two storage regions.

7. An image display system, comprising:
an image precessing device; and
an electro-optic apparatus, comprising:
a pixel matrix, where pixels including optical elements are arranged in a matrix shape;
a plurality of scanning lines coupled to a pixel group arranged along either one of a row direction or a column direction of the pixel matrix;
a plurality of data lines coupled to the pixel group arranged along either one of the row direction or the column direction of the pixel matrix;
a scanning-line driving circuit that sequentially selects the plurality of scanning lines one by one;
a data-line driving circuit that outputs a control signal related to light emission of the optical elements to, at least, one data line of the plurality of data lines;
a control section that controls an operation of the scanning-line driving circuit and the data-line driving circuit; and
an input image data acquisition means for obtainings input image- data transmitted from the image processing device,
wherein the image processing device generates the input image data to be inputted into the electro-optic apparatus and transmits the input image data to the electro-optic apparatus, and
wherein the control section that controls the light emission time of the optical elements by a non-sequential scanning operation that selects a scanning line in a discontinuous order against an arranged order of the scanning lines, based on gradation data of a predetermined bit length corresponding to the input image data and a number of light emission gradation of the optical elements, and gradationally displays an input image on a display area defined by a predetermined number of the scanning lines and the data lines.

8. The image display system according to claim 7, wherein a predetermined amount of pixel data, with a rearrangement that has been completed, is transmitted to the electro-optic apparatus every time the rearrangement has been completed.

9. The image display system according to claim 7, wherein the image processing device comprises:
an input image data generation section;
a frame memory; and
an input image data transmission section.

10. The image display system according to claim 9, wherein the input image data generation section carries out image processing obtained from a personal computer to generation the input image data.

11. The image display system according to claim 10, wherein the input image data is rearranged according a selection order of the scanning lines by the non-sequential scanning operation in the electro-optic apparatus.

12. The image display system according to claim 9, wherein the frame memory includes two storage regions.

13. A method for manufacturing image processing device, comprising:
arranging pixels including optical elements in a matrix shape;
coupling a plurality of scanning lines to a pixel group arranged along either one of a row direction or a column direction of a pixel matrix;
coupling a plurality of data lines to the pixel group arranged along either one of the row direction or the column direction of the pixel matrix;
sequentially selecting the plurality of scanning lines one by one by a scanning line driving circuit;
outputting a control signal related to light emission of the optical elements to, at least, one data line of the plurality of data lines by a data-line driving circuit;
controlling an operation of the scanning-line driving circuit and the data-line driving circuit;
obtaining input image data transmitted from an image processing device;
generating the input image data to be inputted into an electro-optic apparatus and transmitting the input image data to the electro-optic apparatus; and
controlling the light emission time of the optical-elements by a non-sequential scanning operation that selects a scanning line in discontinuous order against an arranged order of the scanning lines, based on gradation data of a predetermined bit length corresponding to the input image data and a number of light emission gradation of the optical elements, and gradationally displays an input image on a display area defined by a predetermined number of the scanning lines and the data lines.

14. The method according to claim 13, further comprising:
obtaining a bit length N of the gradation data indicating the light emission gradation of the optical elements and a numerical group obtained by dividing an added number, obtained by adding one to a total number of the scanning lines, with a proportion comprising 2ⁿ values (n=0, 1 and 2 through (N−1)) of a number of bits in a bit string constituting the gradation data; and
associating a serial number to each of the scanning lines with the arranged order of the scanning lines.

15. The method according to claim 14, further comprising:
assigning a predetermined number of the serial numbers, which have been associated to the scanning lines, as an initial value corresponding to a least significant bit (0th digit) of the bit string constituting the gradation data; and
assigning a number, obtained by adding a largest number contained in the numerical group to the initial value corresponding to the least significant bit, as the initial value of the scanning line corresponding to a most significant bit ((N−1) digit) of the bit string constituting the gradation data.

16. The method according to claim 15, further comprising associating an added value, obtained by adding one to a bit-digit of another bit from a lower bit-digit, as an initial value of the other bit, out of the initial value corresponding to one digit higher than bit-digit of the other bit and the numerical values contained in the numerical group, sequentially from the higher bit-digit of the other bits, concerning the other bits between the most significant bit and the least significant bit.

17. The method according to claim 16, further comprising a first processing that selects the scanning line of the serial number indicated by the initial value corresponding to the least significant bit at first, and sequentially selects each of the scanning line of the serial number indicated by the initial values corresponding to the most significant bit and each bit, which is shifted bit by bit from the most significant bit towards the bit before the least significant bit.

18. The method according to claim 17, further comprising a second processing that makes the scanning-line driving circuit drive the scanning line of the selected number every time the scanning line is selected.

19. The method according to claim 18, further comprising a third processing that adds one to a value that has been associated with each bit of the gradation data, respectively, while if the value corresponding to each bit of the gradation data after the addition exceeds the value, obtained by subtracting one from the total number of the scanning lines, the process updates the value to the minimum value of the serial number.

20. The method according to claim 19, further comprising a fourth processing that selects the scanning line, corresponding to the value that has been associated to each bit of the gradation data after the third processing, with the same sequence of the first processing, wherein a control program for the image processing device determines the selection order of the scanning lines by repeating the second processing through the fourth processing until all the scanning lines on the display area have been selected for each bit of the bit string constituting the gradation data, and generates the input image data based on the determined selection order.
